(19) United States
(12) Patent Application Publication
(10) Pub. No.: US 2024/0369439 A1
(43) Pub. Date: Nov. 7, 2024

(54) SENSOR DEVICE AND APPARATUS AND METHOD FOR MONITORING FAULT OF PIPE

(71) Applicant: ELECTRONICS AND TELECOMMUNICATIONS RESEARCH INSTITUTE, Daejeon (KR)

(72) Inventors: Seon Hyeog KIM, Daejeon (KR); Su Sik BANG, Siheung-si (KR); Yoon Mee DOH, Daejeon (KR); Soon Hyun KWON, Daejeon (KR); Young Mee SHIN, Daejeon (KR); Sang Keum LEE, Daejeon (KR); Jong Jae LEE, Seoul (KR); Joa Hyoung LEE, Daejeon (KR)

(21) Appl. No.: 18/644,601

(22) Filed: Apr. 24, 2024

(30) Foreign Application Priority Data
May 3, 2023 (KR) 10-2023-0057921
Feb. 5, 2024 (KR) 10-2024-0017631

(51) Int. Cl. G01M 3/24

(52) U.S. Cl. CPC G01M 3/243

(57) ABSTRACT

An apparatus for monitoring a fault of a pipe according to an aspect of the present invention includes a processor, and a memory configured to store instructions executed by the processor, wherein the processor generates an ultrasonic guided signal in a pipe through piezoelectric transducers disposed on a circumferential outer surface of the pipe which is a target of which a fault is to be monitored, and monitors a fault of the pipe through signal processing for performing correlation analysis and noise removal on a reflected signal generated by the ultrasonic guided signal being reflected at an arbitrary point of the pipe.

### CROSS-REFERENCE TO RELATED APPLICATIONS

This application claims priority to and the benefit of Korean Patent Application Nos. 10-2023-0057921 and 10-2024-0017631, filed on May 3, 2023 and Feb. 5, 2024, respectively, the disclosure of which is incorporated herein by reference in its entirety.

### BACKGROUND

### 1. Field of the Invention

The present invention relates to an apparatus and method for monitoring a fault of a pipe, and a sensor device applied to monitor a fault of a pipe.

### 2. Description of Related Art

Due to aging infrastructure, air leaks and defects occur in pipes such as cold water pipes, hot water pipes, gas pipes, and refrigerant pipes, and thus energy supply efficiency is decreasing, and as related accidents occur continuously, economic losses are very large. Therefore, there is a need for a technology for accurately monitoring and diagnosing the location of a fault of a pipe.

Korean Patent Publication No. 10-2020-0127705 (published on Nov. 11, 2020, hereinafter referred to as related art document) discloses a configuration in which an optimal ultrasonic guided signal is designed in consideration of the characteristics of a pipe to be diagnosed and generated in a longitudinal direction of the pipe, and the location and degree of a fault of the pipe are predicted based on a reflected signal reflected at an arbitrary point of the pipe.

Specifically, the related art document discloses a configuration in which an optimal ultrasonic guided signal is generated through a method in which a frequency width value (BW) is calculated according to the specifications of a pipe to be diagnosed, a duration value (TD) is calculated based on the frequency width value, and a center frequency value (CF) is calculated based on the frequency width value and the duration value. In addition, the related art document discloses a configuration in which a reflected signal is converted to a time-frequency domain, and then the converted time-frequency domain is analyzed through a cross correlation function to predict the location and degree of a fault of a pipe to be diagnosed.

Meanwhile, the related art document has a limitation of failing to consider signal interference and distortion caused by surrounding structures of a pipe system when diagnosing a fault of a pipe using an ultrasonic guided signal. That is, in an actual pipe system, as shown in FIG. 1, surrounding structures such as lagging materials and pipe supports are provided, and these surrounding structures cause noise in a reflected signal that is a target to be analyzed for diagnosing a fault of a pipe. Accordingly, it is difficult to distinguish an actual fault of a pipe from surrounding structures, which reduces the accuracy of diagnosing a fault of a pipe.

### SUMMARY OF THE INVENTION

The present invention is directed to providing an apparatus and method for monitoring a fault of a pipe, and a sensor device applied to monitor a fault of a pipe, in which noise caused by surrounding structures of a pipe is removed to clearly distinguish an actual fault of the pipe from the surrounding structures, thereby improving the accuracy of diagnosing the fault of the pipe.

According to an aspect of the present invention, there is provided a sensor device for monitoring a fault of a pipe, the sensor device including a plurality of piezoelectric transducers disposed on a circumferential outer surface of a pipe which is a target of which a fault is to be monitored, wherein the plurality of piezoelectric transducers are disposed at radial equal intervals on the circumferential outer surface of the pipe according to a placement profile defined based on a margin rate defined as a parameter that indicates a density of the piezoelectric transducers disposed on the circumferential outer surface of the pipe.

The margin rate may be defined as a ratio of an interval between the piezoelectric transducers to a width of the piezoelectric transducer.

The placement profile may differentially define the number of the piezoelectric transducers disposed on the circumferential outer surface of the pipe according to a comparison result between the margin rate and a predefined reference value.

When the maximum number of the piezoelectric transducers disposed on the circumferential outer surface of the pipe is defined as k in a state in which the interval between the piezoelectric transducers is set to a value of 0, the placement profile may appear such that, when the margin rate is less than or equal to the reference value, the number of the piezoelectric transducers disposed on the circumferential outer surface of the pipe is defined as a value of “k-α,” wherein α is a subtraction parameter determined based on the reference value and k.

According to another aspect of the present invention, there is provided an apparatus for monitoring a fault of a pipe, the apparatus including a processor, and a memory configured to store instructions executed by the processor, wherein the processor generates an ultrasonic guided signal in a pipe through piezoelectric transducers disposed on a circumferential outer surface of the pipe which is a target of which a fault is to be monitored, and monitors a fault of the pipe through signal processing for performing correlation analysis and noise removal on a reflected signal generated by the ultrasonic guided signal being reflected at an arbitrary point of the pipe.

The ultrasonic guided signal and the reflected signal may be chirp signals having multiple center frequencies, and the processor may convert a domain of the reflected signal into a time-frequency domain and may analyze a correlation between a first projection function in which the reflected signal is projected on a frequency domain and a second projection function in which the reflected signal is projected on a time domain in the time-frequency domain.

The processor may derive a noise parameter indicating a noise component reflected on the reflected signal based on an angle between the reflected signal and a reference axis in the time-frequency domain.

The processor may apply the noise parameter to a result of analyzing the correlation between the first projection function and the second projection function to derive a final monitoring signal for monitoring the fault of the pipe.

According to still another aspect of the present invention, there is provided an apparatus for monitoring a fault of a pipe, the apparatus including a plurality of piezoelectric transducers disposed on a circumferential outer surface of a pipe which is a target of which a fault is to be monitored, a processor configured to generate an ultrasonic guided signal in the pipe through the piezoelectric transducers disposed on the circumferential outer surface of the pipe which is the target of which the fault is to be monitored and monitor a fault of the pipe through signal processing for performing correlation analysis and noise removal on a reflected signal generated by the ultrasonic guided signal being reflected at an arbitrary point of the pipe.

The plurality of piezoelectric transducers may be disposed at radial equal intervals on the circumferential outer surface of the pipe according to a placement profile defined based on a margin rate defined as a parameter that indicates a density of the piezoelectric transducers disposed on the circumferential outer surface of the pipe.

The ultrasonic guided signal and the reflected signal may be chirp signals having multiple center frequencies, and when the number of the piezoelectric transducers disposed on the circumferential outer surface of the pipe is defined as n, an entire frequency band of the ultrasonic guided signal may be designed to be limited by n.

The processor may convert a domain of the reflected signal into a time-frequency domain and may analyze a correlation between a first projection function in which the reflected signal is projected on a frequency domain and a second projection function in which the reflected signal is projected on a time domain in the time-frequency domain.

The processor may derive a noise parameter indicating a noise component reflected on the reflected signal based on an angle between the reflected signal and a reference axis in the time-frequency domain.

The processor may apply the noise parameter to a result of analyzing the correlation between the first projection function and the second projection function to derive a final monitoring signal for monitoring the fault of the pipe.

The processor may generate an ultrasonic guided signal in a torsional mode (T-mode).

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a set of exemplary views illustrating surrounding structures of a pipe;

FIG. 2 is a set of exemplary views illustrating an arrangement structure of a sensor device according to the present embodiment;

FIGS. 3 to 5 are exemplary views for describing a placement profile applied to the sensor device according to the present embodiment;

FIG. 6 is a block diagram illustrating an apparatus for monitoring a fault of a pipe according to the present embodiment;

FIG. 7 is an exemplary diagram showing an ultrasonic guided signal group velocity in the apparatus for monitoring a fault of a pipe according to the present embodiment;

FIG. 8 is an exemplary graph for describing a correlation between projections (CBP) and an instantaneous frequency angle (IFA) in the apparatus for monitoring a fault of a pipe according to the present embodiment;

FIGS. 9 and 10 are exemplary graphs for describing a process of determining a location of a fault of a pipe in the apparatus for monitoring a fault of a pipe according to the present embodiment; and

FIGS. 11 and 12 are flowcharts illustrating a method of monitoring a fault of a pipe according to the present embodiment.

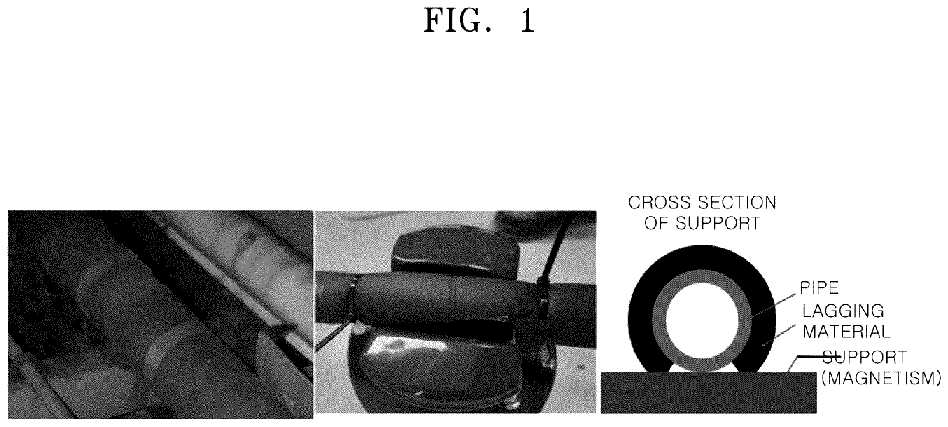

### DETAILED DESCRIPTION OF EXEMPLARY EMBODIMENTS

Hereinafter, exemplary embodiments of the present invention will be described with reference to the accompanying drawings. Prior to the description, it should be understood that terms used in the specification and the appended claims should not be construed as limited to their usual or dictionary meanings, but interpreted based on the meanings and concepts corresponding to technical aspects of the present invention on the basis of the principle that the inventor can appropriately define the concepts of terms in order to describe his/her invention in the best way. Accordingly, since the embodiments described herein and configurations illustrated in the drawings are merely some of the most exemplary embodiments of the present invention and do not represent all of the technical ideas of the present invention, it should be understood that there may be various equivalents and modifications that can replace the embodiments and drawings at the time of filing the present application. Further, the terms comprise and include” and/or “comprising and including” used in this specification should be interpreted as specifying the presence of described shapes, numbers, steps, operations, members, elements, and/or groups thereof and do not exclude the presence or addition of other shapes, numbers, steps, operations, members, elements, and/or groups thereof. Further, the use of “may” and “may be” when describing embodiments of the present invention refers to “one or more embodiments of the present invention.”

In addition, for a better understanding of the disclosure, the accompanying drawings are not illustrated on an actual scale and sizes of some elements can be exaggerated. In addition, the same reference numbers may be assigned to the same components in different embodiments.

Stating that two objects of comparison are “the same” means that the two objects of comparison are “substantially the same.” Therefore, substantially the same may include a deviation that is considered low in the art, for example, a deviation of 5% or less. In addition, uniformity of a parameter in a certain area may mean uniformity from an average perspective.

Although the terms “first,” “second,” and the like are used to describe various components, these components are of course not limited by these terms. These terms are only used to distinguish one element from another element, and a first element may also be a second element unless otherwise stated.

Through the specification, each element may be singular or plural unless otherwise stated.

When it is said that an arbitrary element is disposed on “an upper portion (or a lower portion)” of an element or disposed “above (or below)” an element, this may not only mean that the arbitrary element is disposed in contact with an upper surface (or a lower surface) of the element, but also mean that another element may be interposed between the element and the arbitrary element disposed above (or below) the element.

Also, when it is said that a first element is “connected,” “coupled,” or “combined” to a second element, this may mean that the elements are directly connected or coupled to each other, but it should be understood that a third element may be “interposed” between the elements or the elements may be “connected” or “coupled” to each other via the third element. Further, when a part is said to be “electrically coupled” to another part, this includes not only the case where the parts are directly connected but the case where the parts are connected via another element therebetween.”

Throughout the specification, “A and/or B” refers “A, B, or A and B” unless particularly described otherwise. That is, “and/or” includes all or any combination of a plurality of listed items. “C to D” refers to C or more and D or less unless particularly described otherwise.

### 1. Sensor Device

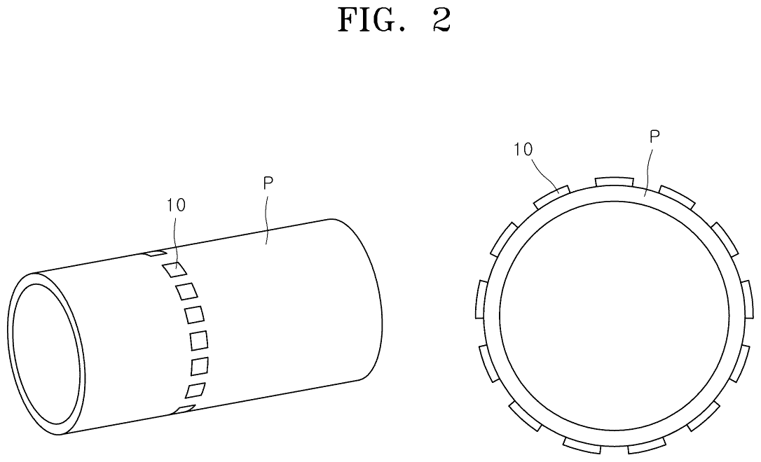

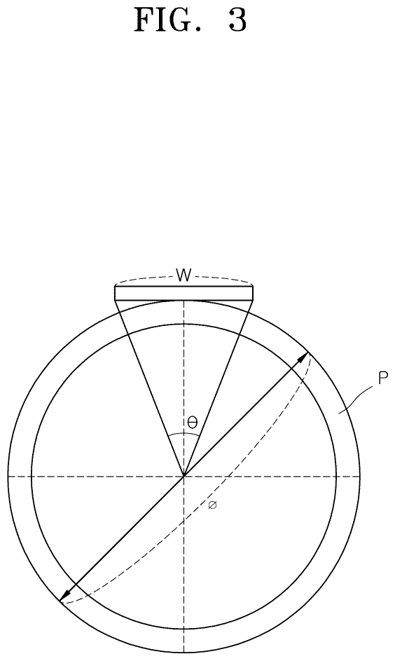

FIG. 2 is a set of exemplary views illustrating a placement structure of a sensor device according to the present embodiment. FIGS. 3 to 5 are exemplary views for describing a placement profile applied to the sensor device according to the present embodiment.

As shown in FIG. 2, the sensor device of the present embodiment may include a piezoelectric transducer 10 for monitoring a fault of a pipe P. A plurality of piezoelectric transducers 10 may be disposed on a circumferential outer surface of the pipe P that is a target of which a fault is to be monitored and may convert an electrical signal applied from a processor 30, which will be described below, into mechanical vibrations. According to mechanical vibrations of the piezoelectric transducer 10, an ultrasonic guided signal may be generated in the pipe P in a longitudinal direction.

Meanwhile, in order to secure desired resolution, a Gaussian enveloped linear chirp (GELC) signal with a wide frequency bandwidth may be applied as an ultrasonic guided signal. Accordingly, in a cylindrical pipe, an ultrasonic guided signal may propagate in three modes: a longitudinal mode (L-mode), a flexural mode (F-mode), and a torsional mode (T-mode). An ultrasonic guided signal in the L-mode and the F-mode among the three modes has characteristics in which a propagation speed varies according to a frequency thereof. Since a GELC signal has a wide frequency bandwidth, when an ultrasonic guided signal propagates in the L-mode and the f-mode, the signal may be distorted due to dispersion which is a phenomenon that occurs due to a propagation speed that varies according to a frequency, which may degrade the performance of ultrasonic guided signal-based time-frequency domain reflectometry. Therefore, it may be desirable for an ultrasonic guided signal to be generated in the T-mode.

In order to generate an ultrasonic guided signal in the T-mode, the piezoelectric transducer 10 of the present embodiment may be implemented as a shear type piezoelectric transducer 10 capable of generating displacement in a circumferential direction of the pipe (that is, a tangential direction of a circumference).

In order to generate a complete ultrasonic guided signal in the T-mode, since displacement should not occur in any direction other than the circumferential direction of the pipe, it is necessary to maintain axisymmetry between the plurality of piezoelectric transducers 10 disposed on the circumferential outer surface of the pipe. The sensor device adopted in the present embodiment for a symmetrical structure between the piezoelectric transducers 10 will be described in detail below.

Referring to FIG. 3, when the piezoelectric transducer 10 is disposed on the outer surface of the pipe P, based on an outer diameter ¢ of the pipe and a length w of the piezoelectric transducer 10 in a direction (lateral direction in FIG. 3) in which the shear type piezoelectric transducer 10 generates mechanical vibrations, a central angle θ assigned to a single piezoelectric transducer 10 in 360° (2π), which is a central angle of the circumference of the pipe, may be calculated according to Expression 1 below.

$$θ = 2 {tan}^{- 1} ( \frac{w}{∅} ) \qquad [ Expression 1 ]$$

From Expression 1 above, in a state in which an interval between the plurality of piezoelectric transducers 10 is set to a value of 0 (that is, in a state in which the plurality of piezoelectric transducers 10 are disposed on the outer surface of the pipe without any interval), the maximum number k by which the piezoelectric transducers 10 may be disposed on the circumferential outer surface of the pipe may be calculated according to Expression 2 below.

$$k = ⌊ \frac{2 π}{θ} ⌋ \qquad [ Expression 2 ]$$

In Expression 2, └┘ is a floor operator.

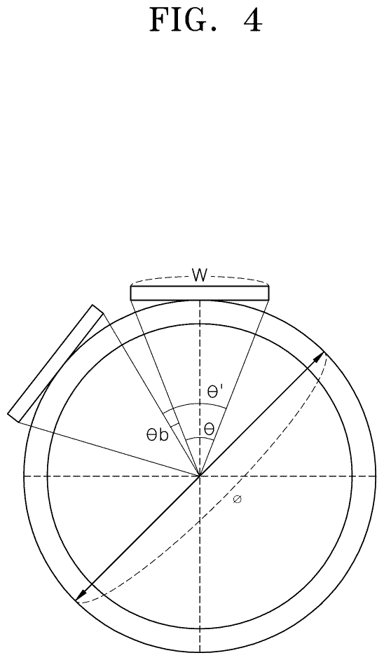

Referring to FIG. 4, when k piezoelectric transducers 10 are disposed at equal intervals on the outer surface of the pipe (for convenience, only two piezoelectric transducers 10 are shown in FIG. 4), the sum θ′ of a central angle θ assigned to a single piezoelectric transducer 10 and a central angle θb assigned to an interval between the piezoelectric transducers 10 may be calculated according to Expression 3 below.

$${θ}^{′} = \frac{2 π}{k} \qquad [ Expression 3 ]$$

When k piezoelectric transducers 10 are disposed according to a combination of an outer diameter of the pipe and a length of the piezoelectric transducer 10 (in a direction of vibration), intervals between the piezoelectric transducers 10 may be different. In order for a short circuit prevention using insulation between the piezoelectric transducers 10 and arrangement of the piezoelectric transducers 10 to surround the outer surface of the pipe, a certain interval is required between the piezoelectric transducers 10. In addition, it is necessary to determine the number of piezoelectric transducers 10 in additional consideration of an interval error that inevitably occurs during a manufacturing process of the sensor device. The following description provides quantitative criteria for determining the number of piezoelectric transducers 10.

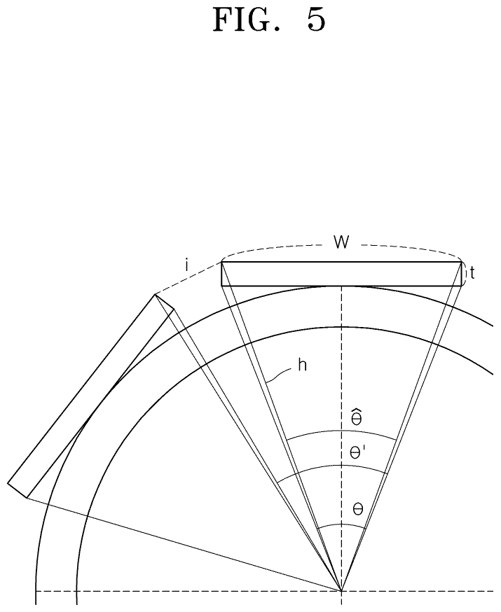

As shown in FIG. 5, when k piezoelectric transducers 10 are disposed at equal intervals on the outer surface of the pipe, an interval i between the piezoelectric transducers 10 (distance between the outermost side ends of adjacent piezoelectric transducers 10) may be expressed according to Expression 4 below based on the modeling of FIG. 5.

$$i = 2 h * sin ( \frac{{θ}^{′} - \hat{θ}}{2} ) \qquad [ Expression 4 ]$$

$$\hat{θ} = 2 {tan}^{- 1} ( \frac{w}{∅ + 2 t} )$$

$$h = \sqrt{{( \frac{∅}{2} + t )}^{2} + {( \frac{w}{2} )}^{2}}$$

In Expression 4, t denotes a thickness of the piezoelectric transducer 10.

Here, a margin rate adopted in the present embodiment is defined. The margin rate is defined as a parameter that indicates a density of the plurality of piezoelectric transducers 10 disposed on the circumferential outer surface of the pipe. A low margin rate may mean that the plurality of piezoelectric transducers 10 are densely disposed on the circumferential outer surface of the pipe, and a high margin rate may mean that the plurality of piezoelectric transducers 10 are disposed relatively less densely on the circumferential outer surface of the pipe. In the present embodiment, the margin rate may be defined as a ratio of an interval between the piezoelectric transducers 10 to a ratio of a width of the piezoelectric transducer 10 (that is, a margin rate=i/w) and may have a value between 0 and 1.

The plurality of piezoelectric transducers 10 may be disposed at radial equal intervals on the circumferential outer surface of the pipe according to a placement profile defined based on the margin rate as described above. The placement profile differentially defines the number of piezoelectric transducers 10 disposed on the circumferential outer surface of the pipe according to a comparison result between the margin rate and a predefined reference value m. The margin rate exceeding the reference value means that, when k piezoelectric transducers 10 are disposed, intervals between the piezoelectric transducers 10 may be sufficiently secured. The margin rate being less than or equal to the reference value means that, when k piezoelectric transducers 10 are disposed, since intervals between the piezoelectric transducers 10 may not be sufficiently secured, it is necessary to reduce the number of piezoelectric transducers 10 to secure the intervals between the piezoelectric transducers 10. The reference value may be predefined based on the designer's intention or the characteristics of the pipe, and, for example, may have a value between 0 and 1 as a value corresponding to a k value.

Expression 5 below expresses an example of a placement profile.

$$n = \{ \begin{matrix}k , & ( \frac{i}{w} > m ) \\ k - α , & ( \frac{i}{w} \leq m )\end{matrix} \qquad [ Expression 5 ]$$

In Expression 5 above, a placement profile appears such that, when the margin rate exceeds the reference value, the number n of piezoelectric transducers 10 is defined as k, and when the margin rate is less than or equal to the reference value, the number of piezoelectric transducers 10 is defined as “k-α.” Here, a may be a subtraction parameter determined based on the reference value m and k and may be expressed, for example, as in Expression 6 below.

$$α = ⌊ m * k + 1 ⌋ \qquad [ Expression 6 ]$$

In Expression 6, └┘ is a floor operator.

The placement profile according to Expressions 5 and 6 may be described as shown in Expression 7 below by solving the expressions of Expressions 1 to 4.

$$n = \{ \begin{matrix}⌊ \frac{π}{{tan}^{- 1} ( \frac{w}{∅} )} ⌋ , & ( \frac{2 \sqrt{{( \frac{∅}{2} + t )}^{2} + {( \frac{w}{2} )}^{2}} * sin ( \frac{π}{⌊ \frac{π}{{tan}^{- 1} ( \frac{w}{∅} )} ⌋} - {tan}^{- 1} ( \frac{w}{∅ + 2 t} ) )}{w} > m ) \\ ⌊ \frac{π}{{tan}^{- 1} ( \frac{w}{∅} )} ⌋ - ⌊ m * ⌊ \frac{π}{{tan}^{- 1} ( \frac{w}{∅} )} ⌋ + 1 ⌋ , & ( \frac{2 \sqrt{{( \frac{∅}{2} + t )}^{2} + {( \frac{w}{2} )}^{2}} * sin ( \frac{π}{⌊ \frac{π}{{tan}^{- 1} ( \frac{w}{∅} )} ⌋} - {tan}^{- 1} ( \frac{w}{∅ + 2 t} ) )}{w} \leq m )\end{matrix} \qquad [ Expression 7 ]$$

As a method of attaching the plurality of piezoelectric transducers 10, there may be a method in which the plurality of piezoelectric transducers 10 are directly attached in a ring structure to the outer surface of the pipe through a certain adhesive material, or a method in which a strap to which the plurality of piezoelectric transducers 10 are attached is attached in a ring structure to the outer surface of the pipe.

### 2. Apparatus for Monitoring Fault of Pipe

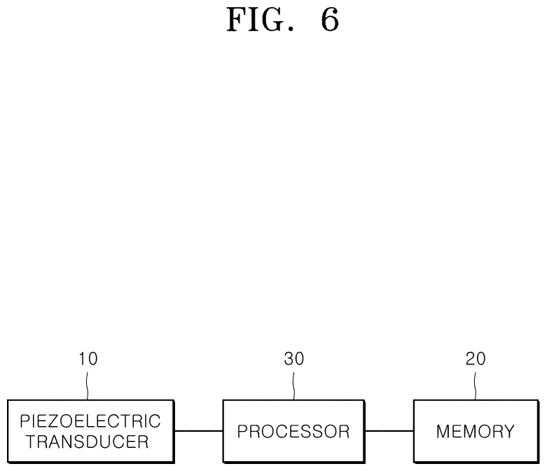

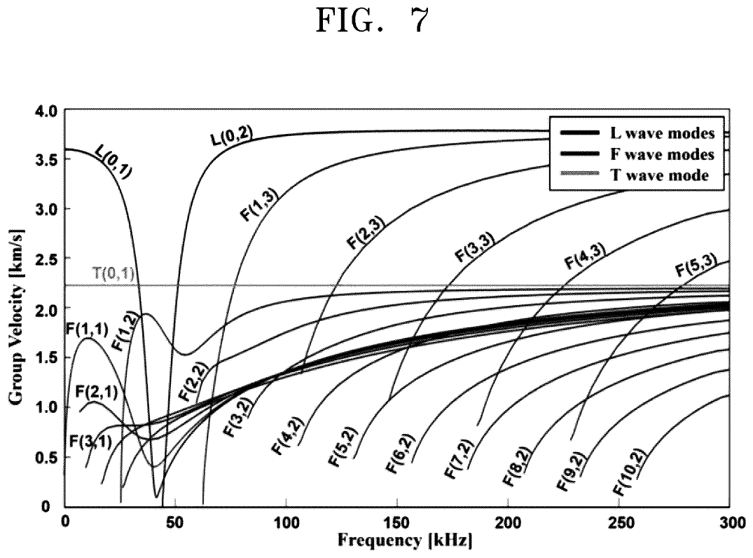

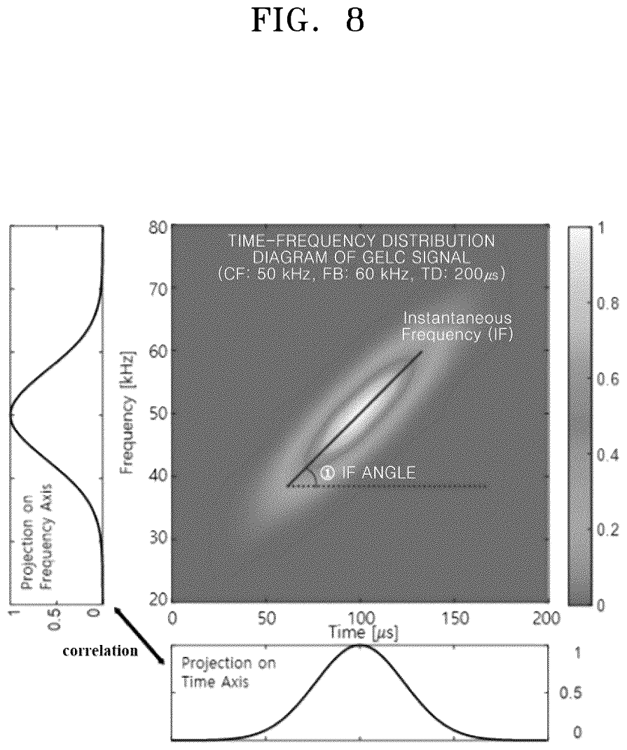

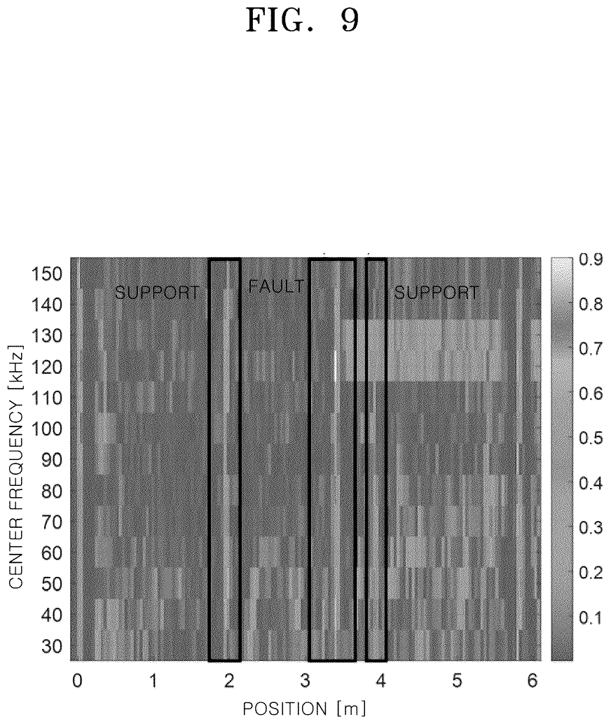

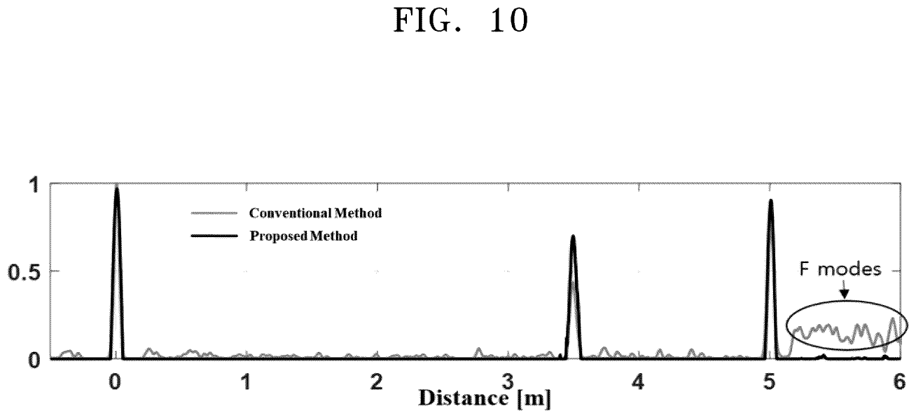

FIG. 6 is a block diagram illustrating an apparatus for monitoring a fault of a pipe according to the present embodiment. FIG. 7 is an exemplary diagram showing an ultrasonic guided signal group velocity in the apparatus for monitoring a fault of a pipe according to the present embodiment. FIG. 8 is an exemplary graph for describing a correlation between projections (CBP) and an instantaneous frequency angle (IFA) in the apparatus for monitoring a fault of a pipe according to the present embodiment. FIGS. 9 and 10 are exemplary graphs for describing a process of determining a location of a fault of a pipe in the apparatus for monitoring a fault of a pipe according to the present embodiment.

Even when a plurality of piezoelectric transducers 10 are disposed on an outer surface of a pipe according to the placement profile described above, since it is impossible to completely generate displacement in a circumferential direction of the pipe, an ultrasonic guided signal in an F mode other than a T-mode is inevitably generated. To this end, the present embodiment adopts a configuration that allows the entire frequency band of an ultrasonic guided signal to be limited by the number n of piezoelectric transducers 10.

Referring to FIG. 6, the apparatus for monitoring a fault of a pipe according to the present embodiment may include the plurality of piezoelectric transducers 10, a memory 20, and a processor 30.

The plurality of piezoelectric transducers 10 may be disposed on a circumferential outer surface of the pipe which is a target of which a fault is to be monitored. Since a placement structure of the piezoelectric transducers 10 has been described above, a detailed description will be omitted.

The memory 20 may store at least one instruction executed by the processor 30 which will be described below. The memory 20 may be implemented as a volatile storage medium and/or a non-volatile storage medium, for example, as a read-only memory (ROM) and/or a random access memory (RAM).

The processor 30 may be a device that performs an operation of monitoring a fault of a pipe, may be implemented as a central processing unit (CPU) or a system-on-chip (SoC), may control a plurality of hardware or software components connected to the processor 30 by running an operating system or application, and may perform processing and calculating on various types of data.

In the present embodiment, the processor 30 may be configured to generate an ultrasonic guided signal in the pipe through the plurality of piezoelectric transducers 10 and monitor a fault of the pipe through signal processing for performing correlation analysis and noise removal on a reflected signal generated by the ultrasonic guided signal being reflected at an arbitrary point of the pipe.

Referring to FIG. 7, when the number of ring-shaped piezoelectric transducers 10 is n, in the ultrasonic guided group velocity graph, an F-mode of F(n,2) may occur, and as shown in FIG. 7, it can be confirmed that F(n,2) occurs only when a frequency is greater than or equal to a cut-off frequency (fc). For example, when the number n of piezoelectric transducers 10 is 8, a cut-off frequency of F(8,2) corresponds to about 200 kHz.

Therefore, in order to maximize the performance of monitoring a fault of a pipe by minimizing interference caused by an F-mode, a GELC signal needs to be designed in a frequency band lower than a cut-off frequency of F (n,2). Furthermore, since the sensitivity of a signal varies according to measurement environments such as the size, length, material, and resonant frequency of a target pipe, when center frequencies of an ultrasonic guided signal are sequentially sweeping instead of monitoring a fault of a pipe through a single ultrasonic guided signal, diagnostic accuracy can be improved.

In the present embodiment, the ultrasonic guided signal and the reflected signal may correspond to a GELC signal with multiple center frequencies. When the number of piezoelectric transducers 10 disposed on the circumferential outer surface of the pipe is defined as n, the entire frequency band of the ultrasonic guided signal may be formed to be limited by n, and specifically, the entire frequency band of the ultrasonic guided signal may be designed to be lower than the cut-off frequency of F(n,2).

When the number of center frequencies is defined as z, an interval between the center frequencies, which is sequentially sweeping, is defined as fᵢ, and a start frequency (to prevent a frequency of the ultrasonic guided signal from becoming 0 Hz due to a frequency bandwidth) is defined as fₛ, a bandwidth of a signal at each center frequency may be expressed according to Expression 8 below (in Expression 8, j is a number from 1 to z).

$${BW}_{j} \leq {f}_{c , j} - {f}_{s} - \{ ( j - 1 ) * {f}_{i} \} \qquad [ Expression 8 ]$$

In Expression 8, f_{c,j} denotes a j^{th} center frequency, and BWⱼ denotes a bandwidth of the j^{th} center frequency.

Since resolution improves as a frequency bandwidth increases, a final bandwidth of a signal at each center frequency may be expressed as in Expression 9 below.

$${BW}_{j} = {f}_{c , j} - {f}_{s} - \{ ( j - 1 ) * {f}_{i} \} \qquad [ Expression 9 ]$$

Meanwhile, as described above, surrounding structures such as a lagging material and a pipe support are provided in a pipe system, and the surrounding structures cause noise according to an F-mode in a reflected signal that is a target to be analyzed for diagnosing a fault of a pipe. The present embodiment adopts a configuration that removes F-mode noise inherent in the above reflected signal through signal processing using a CBP and an IFA.

Specifically, the processor 30 may convert a domain of the reflected signal into a time-frequency domain, and in a time-frequency domain, the processor 30 may analyze a correlation (that is, a CBP) between a first projection function (or a first projection signal) in which the reflected signal is projected on a frequency domain (frequency axis) and a second projection function (or a second projection signal) in which the reflected signal is projected on a time domain (time axis). The correlation may be calculated by multiplying the first projection function and the second projection function, and as shown in FIG. 8, since values of the first and second projection functions each have a value between 0 and 1, the correlation, which is a result of multiplying the two functions also has a value between 0 and 1.

A fault of a pipe may be monitored by applying reflectometry to the CBP which is a result of multiplying the first and second projection functions. However, since the CBP includes F-mode noise caused by surrounding structures, in order to precisely monitor the fault of the pipe, it is necessary to remove the F-mode noise.

To this end, the processor 30 may derive a noise parameter indicating a noise component reflected on the reflected signal based on an angle between the reflected signal and a reference axis in a time-frequency domain. The above reference axis may correspond to an x-axis in a time-frequency domain.

As shown in FIG. 8, a frequency of a reflected signal in a time-frequency domain may be an instantaneous frequency, and in an ideal case in which there is no F-mode noise caused by surrounding structures, as shown in FIG. 8, an angle (defined as an IFA in the present embodiment) between a reflected signal and a reference axis is formed as 45°. Meanwhile, when F-mode noise is caused by surrounding structures, distortion or noise is caused on the first projection function or the second projection function, and as a result, an IFA tends to decrease to be less than 45°.

Therefore, in order to remove F-mode noise caused by surrounding structures, it is necessary to correct the previously derived CBP according to a value of an IFA. Specifically, as the IFA value increases, the CBP needs to be corrected to reduce the CPB.

A noise parameter N derived according to an IFA is expressed as in Expression 10 below.

$$N = 1 - \frac{\vert 45 - θ \vert}{45} , if 0 < θ < 90 ( otherwise N = 0 ) \qquad [ Expression 10 ]$$

Accordingly, the processor 30 may derive the noise parameter through Expression 10 based on the IFA and then may apply the noise parameter to a result of analyzing the correlation between the first projection function and the second projection function to derive a final monitoring signal for monitoring a fault of a pipe. That is, a magnitude of the final monitoring signal may have a value of CBP×N.

Since a fault of a pipe is monitored based on the final monitoring signal as described above, as shown in FIG. 9, surrounding structures (supports) may be clearly distinguished from an actual fault, and as shown in FIG. 10, F-mode noise caused by surrounding structures may be removed.

### 3. Method of Monitoring Fault of Pipe

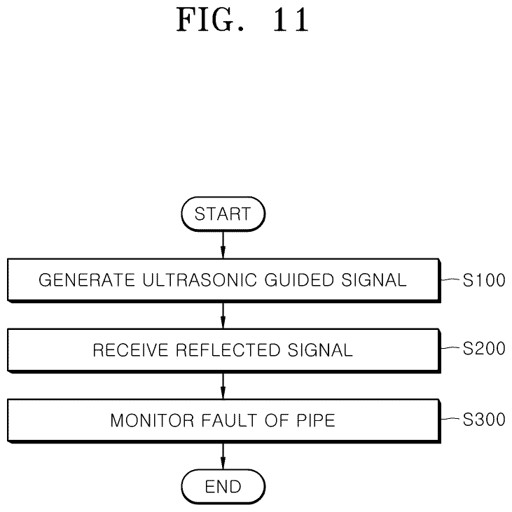

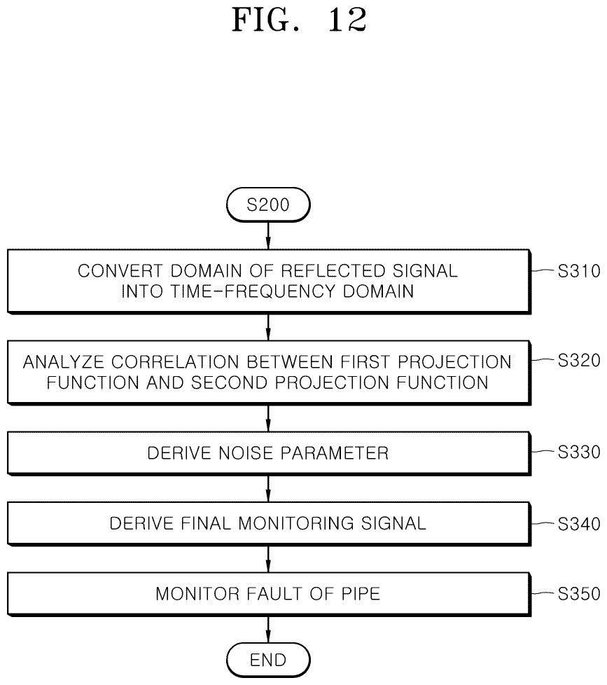

FIGS. 11 and 12 are flowcharts illustrating a method of monitoring a fault of a pipe according to the present embodiment. The method of monitoring a fault of a pipe according to the present embodiment will be described with reference to FIGS. 11 and 12. The detailed descriptions of contents that overlap the above-described contents will be omitted, and the description will focus on the time-series configuration.

First, a processor 30 generates an ultrasonic guided signal inside a pipe through a plurality of piezoelectric transducers 10 (S100). The plurality of piezoelectric transducers 10 may be disposed at radial equal intervals on a circumferential outer surface of the pipe according to a placement profile defined based on a margin rate defined as a parameter that indicates a density of the piezoelectric transducers 10 disposed on the circumferential outer surface of the pipe. Meanwhile, the ultrasonic guided signal may be a GELC signal with multiple center frequencies, and the entire frequency band of the ultrasonic guided signal generated in operation S100 is designed to be limited by the number n of piezoelectric transducers 10 disposed on the circumferential outer surface of the pipe. In addition, in operation S100, the processor 30 may generate an ultrasonic guided signal in a T-mode.

Next, the processor 30 receives a reflected signal generated by the ultrasonic guided signal being reflected at an arbitrary point in the pipe (S200).

Next, the processor 30 monitors a fault of the pipe through signal processing that performs correlation analysis and noise removal on the reflected signal (S300).

In operation S300, the processor 30 converts a domain of the reflected signal into a time-frequency domain (S310). In the time-frequency domain, the processor 30 analyzes a correlation between a first projection function in which the reflected signal is projected on a frequency domain and a second projection function in which the reflected signal is projected on a time domain (S320). The processor 30 derives a noise parameter indicating a noise component reflected on the reflected signal based on an angle between the reflected signal and a reference axis in the time-frequency domain (S330). Thereafter, the processor 30 applies the noise parameter to a result of analyzing the correlation between the first projection function and the second projection function to derive a final monitoring signal for monitoring the fault of the pipe (S340), and applies reflectometry to the derived final monitoring signal to monitor the fault of the pipe (S350).

In this way, according to the present invention, through a structure in which a plurality of piezoelectric transducers are disposed at radial equal intervals on a circumferential outer surface of a pipe according to a placement profile defined based on a margin rate defined as a parameter that indicates a density of the piezoelectric transducers disposed on the circumferential outer surface of the pipe and through signal processing for deriving a final monitoring signal for monitoring a fault of the pipe using a CBP and an IFA, noise caused by surrounding structures in the pipe are removed to clearly distinguish an actual fault of the pipe from the surrounding structures, thereby improving the accuracy of diagnosing the fault of the pipe.

Implementations described herein may be implemented in, for example, a method or process, an apparatus, a software program, a data stream, or a signal. Although discussed only in the context of a single form of implementation (e.g., discussed only as a method), implementations of the discussed features may also be implemented in other forms (for example, an apparatus or a program). The apparatus may be implemented in suitable hardware, software, firmware, and the like. A method may be implemented in an apparatus such as a processor, which is generally a computer, a microprocessor, an integrated circuit, a processing device including a programmable logic device, or the like. Processors also include communication devices such as a computer, a cell phone, a portable/personal digital assistant (“PDA”), and other devices that facilitate communication of information between end-users.

Although the present invention has been described with limited embodiments and drawings, the present invention is not limited to thereto, and instead, it would be appreciated by those skilled in the art that various modifications and changes may be made to these embodiments without departing from the principles and spirit of the present invention, the scope of which is defined by the claims and their equivalents.

What is claimed is:

1. A sensor device for monitoring a fault of a pipe, the sensor device comprising:
a plurality of piezoelectric transducers disposed on a circumferential outer surface of a pipe which is a target of which a fault is to be monitored,
wherein the plurality of piezoelectric transducers are disposed at radial equal intervals on the circumferential outer surface of the pipe according to a placement profile defined based on a margin rate defined as a parameter that indicates a density of the piezoelectric transducers disposed on the circumferential outer surface of the pipe.

2. The sensor device of claim 1, wherein the margin rate is defined as a ratio of an interval between the piezoelectric transducers to a width of the piezoelectric transducer.

3. The sensor device of claim 2, wherein the placement profile differentially defines the number of the piezoelectric transducers disposed on the circumferential outer surface of the pipe according to a comparison result between the margin rate and a predefined reference value.

4. The sensor device of claim 3, wherein, when the maximum number of the piezoelectric transducers disposed on the circumferential outer surface of the pipe is defined as k in a state in which the interval between the piezoelectric transducers is set to a value of 0, the placement profile appears such that, when the margin rate is less than or equal to the reference value, the number of the piezoelectric transducers disposed on the circumferential outer surface of the pipe is defined as a value of “k-α,” wherein α is a subtraction parameter determined based on the reference value and k.

5. An apparatus for monitoring a fault of a pipe, the apparatus comprising:
a processor; and
a memory configured to store instructions executed by the processor,
wherein the processor generates an ultrasonic guided signal in a pipe through piezoelectric transducers disposed on a circumferential outer surface of the pipe which is a target of which a fault is to be monitored, and monitors a fault of the pipe through signal processing for performing correlation analysis and noise removal on a reflected signal generated by the ultrasonic guided signal being reflected at an arbitrary point of the pipe.

6. The apparatus of claim 5, wherein the ultrasonic guided signal and the reflected signal are chirp signals having multiple center frequencies, and
the processor converts a domain of the reflected signal into a time-frequency domain and analyzes a correlation between a first projection function in which the reflected signal is projected on a frequency domain and a second projection function in which the reflected signal is projected on a time domain in the time-frequency domain.

7. The apparatus of claim 6, wherein the processor derives a noise parameter indicating a noise component reflected on the reflected signal based on an angle between the reflected signal and a reference axis in the time-frequency domain.

8. The apparatus of claim 7, wherein the processor applies the noise parameter to a result of analyzing the correlation between the first projection function and the second projection function to derive a final monitoring signal for monitoring the fault of the pipe.

9. An apparatus for monitoring a fault of a pipe, the apparatus comprising:
a plurality of piezoelectric transducers disposed on a circumferential outer surface of a pipe which is a target of which a fault is to be monitored; and
a processor configured to generate an ultrasonic guided signal in the pipe through the piezoelectric transducers disposed on the circumferential outer surface of the pipe which is the target of which the fault is to be monitored and monitor a fault of the pipe through signal processing for performing correlation analysis and noise removal on a reflected signal generated by the ultrasonic guided signal being reflected at an arbitrary point of the pipe.

10. The apparatus of claim 9, wherein the plurality of piezoelectric transducers are disposed at radial equal intervals on the circumferential outer surface of the pipe according to a placement profile defined based on a margin rate defined as a parameter that indicates a density of the piezoelectric transducers disposed on the circumferential outer surface of the pipe.

11. The apparatus of claim 9, wherein the ultrasonic guided signal and the reflected signal are chirp signals having multiple center frequencies, and
when the number of the piezoelectric transducers disposed on the circumferential outer surface of the pipe is defined as n, an entire frequency band of the ultrasonic guided signal is designed to be limited by n.

12. The apparatus of claim 11, wherein the processor converts a domain of the reflected signal into a time-frequency domain and analyzes a correlation between a first projection function in which the reflected signal is projected on a frequency domain and a second projection function in which the reflected signal is projected on a time domain in the time-frequency domain.

13. The apparatus of claim 12, wherein the processor derives a noise parameter indicating a noise component reflected on the reflected signal based on an angle between the reflected signal and a reference axis in the time-frequency domain.

14. The apparatus of claim 13, wherein the processor applies the noise parameter to a result of analyzing the correlation between the first projection function and the second projection function to derive a final monitoring signal for monitoring the fault of the pipe.

15. The apparatus of claim 9, wherein the processor generates an ultrasonic guided signal in a torsional mode (T-mode).
